(19) United States
(12) Patent Application Publication
(10) Pub. No.: US 2011/0116685 A1
(43) Pub. Date: May 19, 2011

(54) INFORMATION PROCESSING APPARATUS, SETTING CHANGING METHOD, AND SETTING CHANGING PROGRAM

(75) Inventor: Saori SUGITA, Tokyo (JP)

(73) Assignee: Sony Corporation, Tokyo (JP)

(21) Appl. No.: 12/887,883

(22) Filed: Sep. 22, 2010

(30) Foreign Application Priority Data
Nov. 16, 2009 (JP) 2009-261093

(51) Int. Cl. G06K 9/00

(52) U.S. Cl. 382/103

(57) ABSTRACT

Disclosed herein is an information processing apparatus including: a detection block configured to detect persons from an image; and a setting changing block configured such that if one of the persons detected by the detection block from the image is designated, then the setting changing block identifies a plurality of attributes of the designated person based on the image of the person, before changing user interface settings using attribute-specific setting information associated with a combination of the identified multiple attributes.

### BACKGROUND OF THE INVENTION

1. Field of the Invention

The present invention relates to an information processing apparatus, a setting changing method, and a setting changing program. More particularly, the invention relates to an information processing apparatus, a setting changing method, and a setting changing program for changing user interface settings.

2. Description of the Related Art

Today, many information processing apparatuses incorporate a graphic user interface, or so-called GUI. Digital still cameras constitute one such information processing apparatus designed to display on its screen not only images taken of objects but also shooting-related information (in characters and graphics). The screen allows the user to verify and change camera settings as needed.

Meanwhile, the user interface (UI) is an important factor directly affecting the ease of use of the information processing apparatus in question. Obviously, the user interface should preferably be as easy to use for the user as possible.

So far, there have been proposed display apparatuses designed to change user interface settings in keeping with the user's age (specifically, to change the font size of text information displayed on a screen). One such apparatus is disclosed illustratively in Japanese Patent Laid-open No. Hei 11-15817.

### SUMMARY OF THE INVENTION

Age is only one of the user's attributes (further including gender and race, among others). The above-mentioned type of display apparatus identifies the user's age by prompting the user to input his or her age. With the user's age thus determined, the user interface settings are changed accordingly.

If the number of the attributes the user is prompted to input is increased so as to identify the user's attributes in a more detailed manner, the ease of use of the user interface is supposed to be enhanced further. However, although the increased number of the input attributes is expected to contribute to the ease of use of the user interface, the need to input numerous attributes can become a cumbersome task for the user to undertake.

The present invention has been made in view of the above circumstances and provides an information processing apparatus, a setting changing method, and a setting changing program for enhancing the ease of use of the apparatus in simplified fashion.

In carrying out the present invention and according to one embodiment thereof, there is provided an information processing apparatus including: a detection block configured to detect persons from an image; and a setting changing block configured such that if one of the persons detected by the detection block from the image is designated, then the setting changing block identifies a plurality of attributes of the designated person based on the image of the person, before changing user interface settings using attribute-specific setting information associated with a combination of the identified multiple attributes.

When structured as outlined above, the information processing apparatus of the present embodiment need only have a displayed person designated by the user from the image with no need for the user specifically to input his or her own attributes. The information processing apparatus then identifies a plurality of attributes of the user and may change the user interface settings based on the identified multiple attributes.

According to the embodiments of the present invention, the user is freed from the task of inputting his or her attributes and has only to designate a displayed person from the image. Designating the imaged person allows the information processing apparatus to identify a plurality of the user's attributes and to change the user interface settings in accordance with the identified multiple attributes. The inventive information processing apparatus, along with a setting changing method and a setting changing program implemented in conjunction therewith, provides enhanced ease of use in a simplified manner.

### BRIEF DESCRIPTION OF THE DRAWINGS

Further features and advantages of the present invention will become apparent upon a reading of the following description and appended drawings in which:

FIG. 1 is a block diagram showing a functional structure of an information processing apparatus profiling an embodiment of the present invention;

FIG. 2 is a schematic view showing a typical structure of a user interface (UI) setting system;

FIG. 3 is a block diagram showing a hardware structure of a digital still camera (DSC);

FIG. 4 is a block diagram showing a hardware structure of an administrative server;

FIG. 5 is a tabular view showing a typical structure of attribute-specific user interface setting information;

FIGS. 6A and 6B are schematic views explanatory of the selection of a target user;

FIG. 7 is a schematic view showing a typical structure of a user interface setting verification screen;

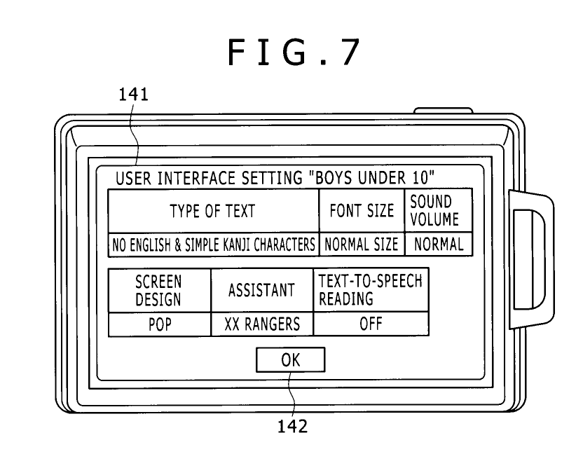

FIG. 8 is a tabular view explanatory of the display of a set value list;

FIG. 9 is a schematic view showing a typical structure of person-specific user interface setting information;

FIG. 10 is a flowchart showing a user interface setting changing routine;

FIG. 11 is a block diagram showing a functional structure of the digital still camera (DSC);

FIGS. 12A and 12B are schematic views explanatory of the selection (part 1) of the target user by another embodiment; and

FIG. 13 is a schematic view explanatory of the selection (part 2) of the target user by a further embodiment.

### DETAILED DESCRIPTION OF THE PREFERRED EMBODIMENTS

The preferred embodiments (simply called the embodiment hereunder) of the present invention will now be described under the following headings:
1. Embodiment
2. Other Embodiments

### <1. Embodiment>

### [1-1. Outline of the Embodiment]

The preferred embodiment of the present invention is first outlined below. The outline is followed by an explanation of specific examples of the embodiment.

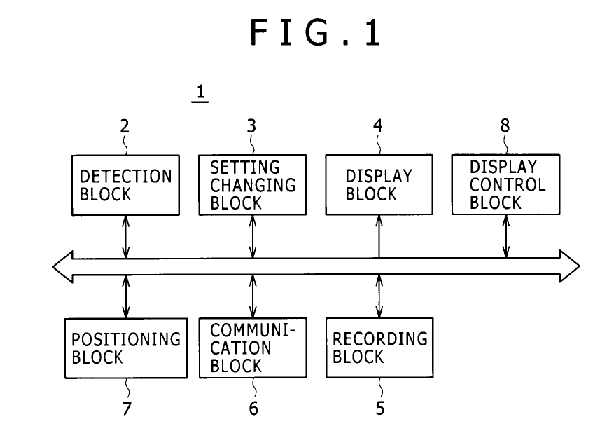

In FIG. 1, reference numeral 1 denotes an information processing apparatus that includes a detection block 2 for detecting persons from an image. The information processing apparatus 1 also includes a setting changing block 3. If one of the persons detected by the detection block 2 from the image is designated, then the setting changing block 3 identifies a plurality of attributes of the designated person based on the image of the person, before changing user interface settings using attribute-specific setting information associated with a combination of the identified multiple attributes.

When structured as outlined above, the information processing apparatus 1 need only have a displayed person designated by the user from the image with no need for the user specifically to input his or her attributes. The information processing apparatus 1 then identifies a plurality of attributes of the user and may change the user interface settings based on the identified multiple attributes.

The information processing apparatus 1 may preferably be arranged in such a manner that if any portion other than the persons detected by the detection block 2 from the image is designated, then the setting changing block 3 may change the user interface settings to initial settings.

The attribute-specific setting information describes set values for changing the user interface settings. The setting changing block 3 changes the user interface settings using the set values described in the attribute-specific setting information.

The setting changing block 3 may preferably cause a display block 4 to display the set values indicated in the attribute-specific setting information associated with the combination of the identified multiple attributes. In such a case, in response to operations by the user to change the displayed set values, the setting changing block 3 may change the displayed set values while changing the user interface settings using the changed set values.

The setting changing block 3 may preferably cause a recording block 5 to record person-specific setting information indicative of the changed user interface settings in association with the person designated from the image.

The information processing apparatus 1 may preferably be arranged further to include a communication block 6 for communicating with an external apparatus. The communication block 6 may receive the attribute-specific setting information from the external apparatus while transmitting the person-specific setting information to the external apparatus.

The information processing apparatus 1 may preferably be arranged further to include a positioning block 7 for determining the current position of the apparatus. In this case, the attribute-specific setting information may be recorded in the recording block 5 in conjunction with combinations of a plurality of attributes with the current position. The setting changing block 3 may then change the user interface settings using the attribute-specific setting information associated with combinations of the identified multiple attributes with the current position determined by the positioning block 7.

The information processing apparatus 1 may preferably be arranged further to include a display control block 8 for displaying a predetermined image on the display block 4 when turned on. In this case, the detection block 2 may detect persons from the image displayed on the display block 4.

Specific examples of the components making up the information processing apparatus 1 structured as described above are explained below in detail.

### [1-2. System Configuration of the User Interface Setting System]

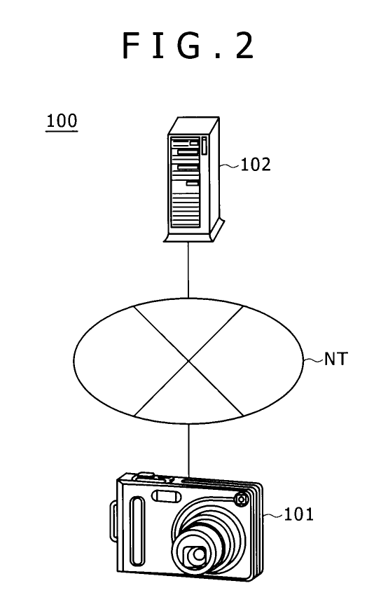

Specific examples of the information processing apparatus 1 according to the present embodiment will now be described. In FIG. 2, reference numeral 100 denotes a user interface (UI) setting system. The user interface setting system 100 is constituted by a digital still camera (called the DSC hereunder) 101 and by an administrative server 102 that manages user interface setting information (to be explained later in detail) for changing the user interface settings of the DSC 101.

In the user interface setting system 100, the DSC 101 changes the user interface settings based on the user interface setting information. Also, the DSC 101 downloads the user interface setting information from the administrative server 102 via a network NT.

### [1-2-1. Hardware Structures of the DSC and Administrative Server]

Explained below are typical hardware structures of the DSC 101 and administrative server 102 making up the user interface setting system 100.

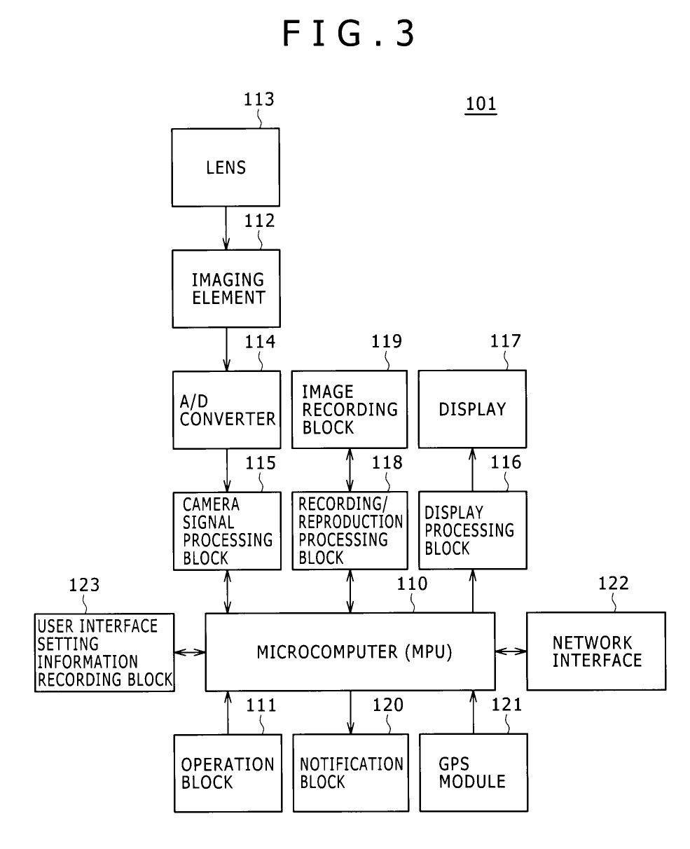

First, the hardware structure of the DSC 101 is explained. As shown in FIG. 3, the DSC 101 contains a microcomputer (called the MPU) 110 made up of a CPU, a ROM, and a RAM. When the MPU 110 is in operation, the CPU loads programs from the ROM into the RAM for program execution whereby the components of the DSC 101 are controlled and diverse processes are carried out.

The MPU 110 recognizes operations performed by the user based on an input signal coming from an operation block 111. The operation block 111 typically includes a shutter button and a touch panel.

Illustratively, the MPU 110 may recognize the user carrying out operations on the operation block 111 attempting to change operation mode to shooting mode. In that case, the MPU 110 changes operation mode to shooting mode.

At this point, an imaging element 112 converts light taken from an object through a lens 113 into an electrical signal (in what is known as photoelectric conversion). The electrical signal thus generated is converted to a digital image signal by an analog-to-digital converter (A/D converter) 114. The digital image signal thus generated is input to a camera signal processing block 115.

The camera signal processing block 115 performs on the image signal such signal processing as auto focusing and image quality correction, before outputting the processed image signal to a display processing block 116. Under control of the MPU 110, the display processing block 116 converts the image signal into a signal ready for display on the screen of a display device 117. The image signal thus converted is sent to the display device 117.

As a result, the display device 117 displays an image of the object in the form of a through-image (also known as a monitoring image). The displayed image allows the user to verify the object being imaged.

At this point, the display processing block 116 under control of the MPU 110 superposes graphics signals such as icons, buttons and text information onto the image signal being output from the camera signal processing block 115. This enables the display device 117 to display on its screen the icons, buttons and text information along with the through-image.

Also, the camera signal processing block 115 processes the image signal to detect the faces of persons in what is known as a face detection process. On detecting the faces of persons as a result of the face detection process, the camera signal processing block 115 notifies the MPU 110 of the positions and sizes of the faces within the image. Based on the notification, the MPU 110 controls the display processing block 116 to display frames encompassing the persons' faces on the through-image (the frames may be called the face frames).

By getting the face frames superposed on the through-image, the DSC 101 informs the user that the faces of persons have been detected.

Suppose now that, say, the shutter button of the operation block 111 is pressed to designate recording of an image. At this point, a recording/reproduction processing block 118 under control of the MPU 110 compression-encodes an image signal output from the camera signal processing block 115. The compression-encoded image signal is recorded to an image recording block 119 as an image file. Illustratively, the image recording block 119 may be a detachable recording medium. This is how the DSC 101 has the taken images recorded therein.

Meanwhile, the MPU 110 may receive an instruction through the operation block 111 ordering the changing of operation node to reproduction mode. In response, the MPU 110 changes operation mode to reproduction mode.

In reproduction mode, the recording/reproduction processing block 118 under control of the MPU 110 reproduces an original image signal by reading and decoding the corresponding image file from the image recording block 119. The reproduced image signal is sent to the display processing block 116. Under control of the MPU 110, the display processing block 116 converts the image signal into a signal ready for display on the display device 117, before forwarding the signal to the display device 117.

As a result, the display device 117 displays an image derived from the image file. This is how the DSC 101 reproduces recorded images.

Also, the MPU 110 may recognize the user carrying out operations on the operation block 111 to change images. In that case, the MPU 110 controls the recording/reproduction processing block 118 to read the next image file from the image recording block 119 in order to display the next image.

At the same time, the MPU 110 in reproduction mode may control the display processing block 116 as needed to display icons, buttons, text information, and/or face frames on the display device 117 along with the image.

The DSC 101 further includes a notification block 120 made up of an LED (light emitting diode) and a speaker. The notification block 120 may cause the speaker to output a sound based on an audio signal coming from the MPU 110 or cause the LED to illuminate under control of the MPU 110.

More specifically, the MPU 110 may convert the text information displayed on the screen into an audio signal and cause the notification block 120 to output the sound based on the audio signal through the speaker. This is how the notification block 120 provides text-to-speech reading based on the text information displayed on the screen. Under control of the MPU 110, the notification block 120 may cause the LED to flash while a self-timer is operating.

The DSC 101 also includes a GPS (Global Positioning System) module 121. The GPS module 121 receives signal from a plurality of GPS satellites and determines the current position of the DSC 101 based on the received signals.

The MPU 110 acquires from the GPS module 121 information indicative of the current position (also called the current position information). The current position information thus obtained is attached to the image file as information denoting the shooting location (known as the shooting location information).

The DSC 101 is further provided with a wired or wireless network interface (I/F) 122. Through the network interface 122, the MPU 110 communicates with the administrative server 102 connected to the network NT.

The DSC 101 is also provided with a user interface setting information recording block 123. The user interface setting information recording block 123 has user interface setting information recorded therein beforehand.

On the basis of the user interface setting information recorded in the user interface setting information recording block 123, the MPU 110 changes user interface settings so that the settings will be optimally suited for the user operating the DSC 101. Specific ways to change the user interface settings will be discussed later. The user operating the DSC 101 is called the target user in this specification.

The MPU 110 may download the latest user interface setting information as needed from the administrative server 102. The MPU 110 proceeds to replace the old user interface setting information held in the user interface setting information recording block 123 with the newly downloaded information.

Incidentally, the DSC 101 is a specific example of the information processing apparatus 1 outlined in the summary of the invention. The camera signal processing block 115 of the DSC 101 is a specific example of the detection block 2 of the inventive information processing apparatus 1. The MPU 110 of the DSC 101 constitutes specific examples of the setting changing block 3 and display control block 8 of the information processing apparatus 1. The user interface setting information recording block 123 of the DSC 101 is a specific example of the recording block 5 of the information processing block 1. The network interface 122 of the DSC 101 is a specific example of the communication block 6 of the information processing apparatus 1. The GPS module 121 of the DSC 101 is a specific example of the positioning block 7 of the information processing apparatus 1.

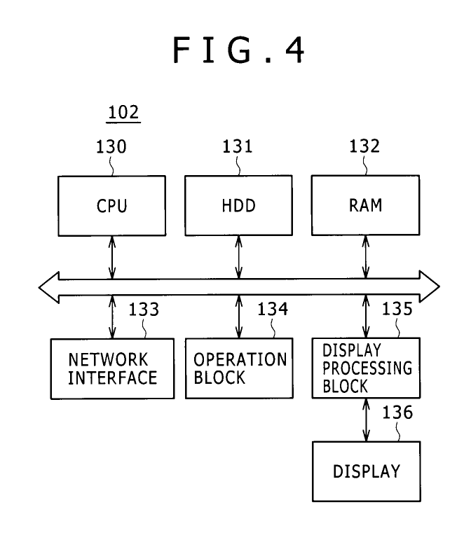

What follows is an explanation of a typical hardware structure of the administrative server 102. As shown in FIG. 4, a CPU 130 of the administrative server 102 loads programs from a hard disk 131 into a RAM 132 for program execution whereby the components of the administrative server 102 are controlled and diverse processes are carried out.

The administrative server 102 includes a network interface 133. Through the network interface 133, the CPU 130 communicates with the DSC 101 connected to the network NT.

The hard disk 131 has user interface setting information stored and managed thereon. Upon receipt via the network interface 133 of a request from the DSC 101 to download the user interface setting information, the CPU 130 transmits to the DSC 101 the user interface setting information retrieved from the hard disk 131.

The administrative server 102 further includes an operation block 134, a display processing block 135, and a display device 136. Given an input signal from the operation block 134, the CPU 130 recognizes the user's operation accordingly. The CPU 130 also causes the display processing block 135 to display results of various processes on the display device 136.

### [1-2-2. Changing of the User Interface Settings]

What follows is a detailed description of how the DSC 101 changes its user interface settings. The user interface setting information will now be explained.

The user interface setting information recording block 123 of the DSC 101 has attribute-specific user interface setting information and person-specific user interface setting information recorded therein as the user interface setting information. The attribute-specific user interface setting information is first explained below.

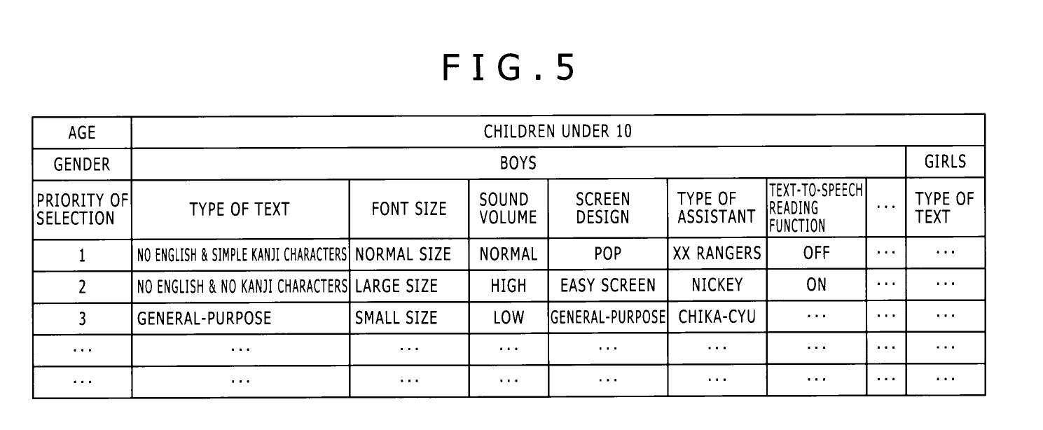

As shown in FIG. 5, the attribute-specific user interface setting information is prepared beforehand in categorized fashion by age bracket and by gender, such as “boys under 10” or “women in their 20's.” The attribute-specific user interface setting information in each category constitutes the user interface settings suited for the target user corresponding to the category in question (defined by age bracket and by gender).

The user interface settings indicated in the attribute-specific user interface setting information may illustratively include “type of text (for display on the screen),” “font size,” “sound volume,” “screen design,” “type of assistant (offering operation guidance),” and “text-to-speech reading function (being on/off).”

More specifically, the “type of text (for display on the screen)” is a user interface setting that specifies whether or not to use English and kanji characters in the text to be displayed on the display device 117. The “type of assistant (offering operation guidance)” is a user interface setting that designates the character to be displayed on the display device 117 as the assistant offering guidance for how to operate the DSC 101.

The attribute-specific user interface setting information describes set values corresponding to each of these user interface settings (the set values are thus called the user interface set values as well).

It should be noted that not one but a plurality of selectable user interface set values are described with regard to each of the above-mentioned user interface settings, each set value being provided with a priority of selection.

The priority of selection is a priority that indicates which of the selectable multiple user interface set values should be selected preferentially. In other words, the priority of selection indicates which of the multiple user interface set values is optimally suited for the target user. The priority is represented by an integer of at least 1. The smaller the number of the priority, the higher the priority in question. That is, the user interface set value having the priority of selection of “1” is the set value best suited for the target user (called the optimal user interface set value).

In the example of FIG. 5, one of the user interface settings of the attribute-specific user interface setting information regarding “boys under 10” is “sound volume” having a plurality of selectable user interface set values “normal,” “high,” “low,” etc.

The set values “normal,” “high,” “low,” etc., are matched with the priorities of selection of “1,” “2,” “3,” etc., respectively in the attribute-specific user interface setting information.

Thus the attribute-specific user interface setting information shows that the “sound volume” optimally suited for “boys under 10” is “normal.” The set value “normal” in this case means the default sound volume.

As described, the attribute-specific user interface setting information of each category describes a plurality of selectable user interface set values with regard to each of the aforementioned user interface settings. The attribute-specific user interface setting information also indicates which of the multiple user interface set values regarding the setting of interest is optimally suited for the target user belonging to the category in question.

The DSC 101 uses the attribute-specific user interface setting information to change user interface settings so that the setting will be optimally suited for the target user who operates the DSC 101.

In this case, the MPU 110 of the DSC 101 first identifies the age and gender of the target user.

More specifically, the MPU 110 allows the user to select the face of the target user from an image. An image analysis process performed on the image of the selected face enables the MPU 110 to identify the age and gender of the target user.

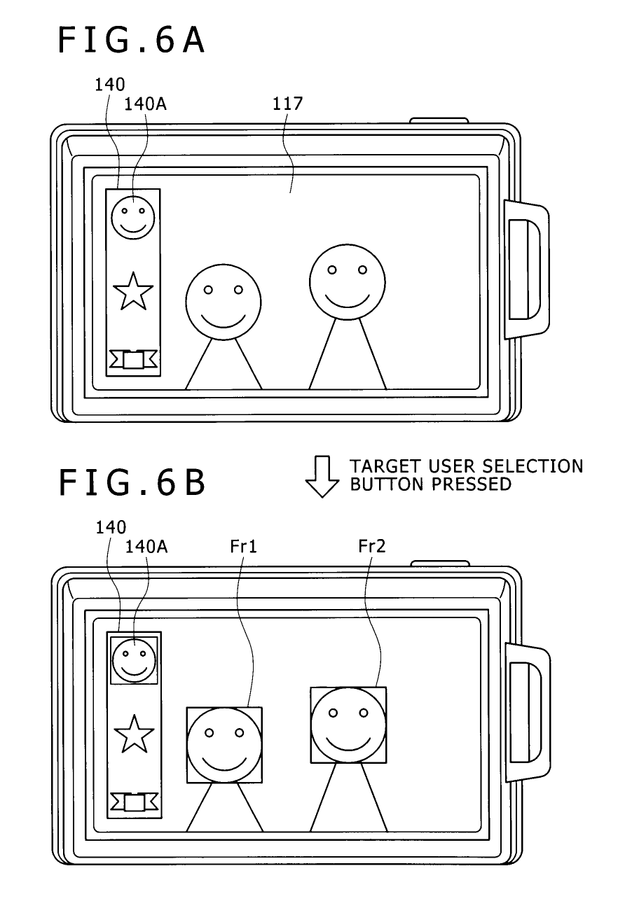

In reproduction mode, with a given image displayed on the display device 117, the MPU 110 may recognize operations carried out by the user on the operation block 111 to get a menu displayed. In that case, the MPU 110 causes a menu 140 to appear on the left-hand side of the screen as shown in FIG. 6A.

In the menu 140, a target user selection button 140A for selecting the target user's face is displayed.

The MPU 110 may recognize the target user selection button 140A being pressed on the touch panel of the operation block 111. In such a case, the MPU 110 controls the camera signal processing block 115 to perform a face detection process on the image being displayed.

Upon detection of the face of a person through the face detection process from the currently displayed image, the camera signal processing block 115 notifies the MPU 110 of the position and size of the detected face within the image.

Given the notification, the MPU 110 controls the display processing block 116 to display face frames Fr on the currently displayed image, as shown in FIG. 6B. FIGS. 6A and 6B show an example where two persons' faces are detected from the currently displayed image and where two face frames Fr1 and Fr2 encompassing the faces are displayed.

Suppose now that the user selects the face enclosed by the face frame Fr2 as the target user's face by touching somewhere inside the face frame Fr2.

The MPU 110 recognizes the selection through the touch panel of the operation block 111. In this case, the MPU 110 establishes the face enclosed by the face frame Fr2 as the target user's face.

Also, the MPU 110 controls the camera signal processing block 115 to isolate the portion enclosed by the face frame Fr2 from the currently displayed image in order to generate a face image of the target user.

The MPU 110 proceeds to perform image analysis on the target user's face image generated by the camera signal processing block 115 so as to determine the age and gender of the target user.

The age to be determined here is not a specific age such as “35” or “18” but an age bracket such as “under 10” or “in (their) 20's.”

Various algorithms have been known as methods for determining the person's age (bracket) from the face image. For example, a plurality of feature quantities such as the shape and color of the face, hairstyle, wrinkles, and the positions of the eyes and mouth are detected from the face image. The detected feature quantities are classified into a predetermined number of groups. For each group, the feature quantities are compared with prepared feature quantities by age bracket. Of the age brackets prepared for each group, the bracket found applicable most often as a result of the comparison is determined as the age bracket of the person whose face image has been analyzed.

Also, diverse algorithms have been known as methods for determining the gender of the person from his or her face image. For example, feature quantities such as the shape and color of the face, hairstyle, and the positions of the eyes and mouth are detected. The detected feature quantities are compared with prepared feature quantities by gender. From the comparison, the gender with the higher correlation value of the two is determined as the gender of the person in question.

Using the aforementioned algorithms, the MPU 110 determines the age and gender of the target user from his or her face image.

Also, from the user interface setting information recording block 123, the MPU 110 reads the attribute-specific user interface setting information of the category corresponding to the age bracket and gender of the target user thus determined. That is, if the age bracket of the target user is determined to be “under 10” and the gender of the target user is determined to be “male,” then the MPU 110 reads the attribute-specific user interface setting information associated with the category of “boys under 10.”

Furthermore, from the attribute-specific user interface setting information, the MPU 110 acquires an optimal user interface set value (i.e., user interface set value optimally suitable for “boys under 10”) with regard to each user interface setting. The MPU 110 then controls the display processing block 116 to display on the display device 117 a user interface setting verification screen 141 prompting the user to verify the user interface se values of the user interface settings in effect.

The user interface setting verification screen 141 shows an OK button 142 along with the optimal user interface set values for each of the user interface settings.

The user may press the OK button 142 after verifying the optimal user interface set values regarding each of the user interface settings being displayed on the user interface setting verification screen 141.

When the OK button 142 is operated as described, the MPU 110 recognizes the operation through the touch panel of the operation block 111. The MPU 110 then changes the user interface settings by replacing the user interface set values of the currently established user interface settings with the optimal user interface set values of the user interface settings being displayed on the user interface setting verification screen 141.

As a result, the user interface settings of the DSC 101 are changed to those of the target user (e.g., who may belong to the category of “boys under 10”).

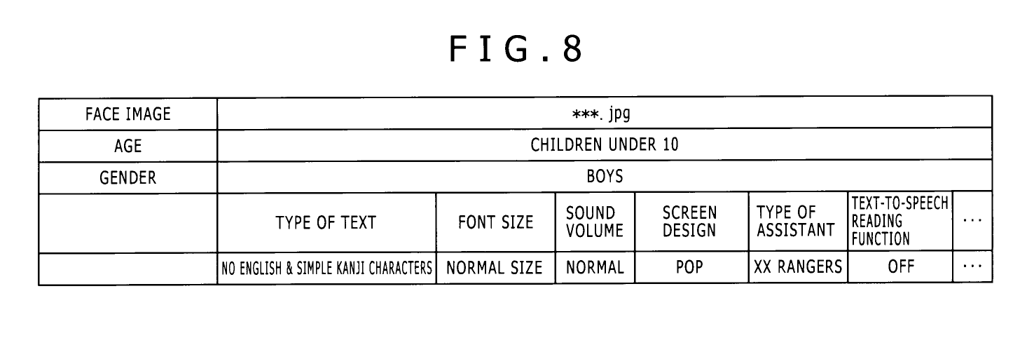

At this point, the MPU 110 generates person-specific user interface setting information on the target user describing the optimal user interface set values of the user interface settings displayed on the user interface setting verification screen 141 as shown in FIG. 8. The MPU 110 proceeds to store the person-specific user interface setting information into the user interface setting information recording block 123 together with the face image of the target user.

The MPU 110 associates the face image of the target user with the person-specific user interface setting information on the target user by writing a file name (e.g., “***.jpg”) of the target user's face image to the person-specific user interface setting information. The MPU 110 also writes the target user's age bracket and gender determined earlier to the person-specific user interface setting information.

Thereafter, whenever the face image of the target user is selected again, the MPU 110 reads the person-specific user interface setting information associated with the target user's face image instead of the attribute-specific user interface setting information in order to change the user interface settings. The MPU 110 then displays on the user interface setting verification screen 141 the optimal user interface set values of the user interface settings described in the person-specific user interface setting information in question.

The optimal user interface set values described in the attribute-specific user interface setting information are obtained by first categorizing users by age bracket and by gender so that the values are acquired statistically for each category. As such, the optimal user interface set values are thought to be best suited for many target users. On the other hand, some target users may desire user interface set values different from those described in the attribute-specific user interface setting information.

With the above possibility taken into account, the user interface setting verification screen 141 presents the optimal user interface set values of each user interface setting in such a manner that the user may choose from the selectable user interface set values as desired.

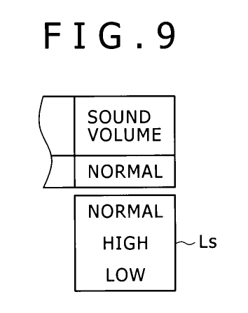

More specifically, when the user selects a desired optimal user interface set value by touching it on the user interface setting verification screen 141, a list of selectable user interface set values (also called the set value list) Ls appears under the selected optimal user interface set value, as shown in FIG. 9.

Based on the attribute-specific user interface setting information, the set value list Ls indicates selectable user interface set values illustratively from the top down in descending order of priority.

The user then selectively touches a desired user interface set value from among the selectable user interface set values displayed in the set value list Ls on the user interface setting verification screen 141. This changes the optimal user interface set value to the set value touched by the user.

The user may change the optimal user interface set value regarding each of the user interface settings displayed on the user interface setting verification screen 141, before pressing the OK button 142.

This causes the MPU 110 to replace the currently established user interface set values of the user interface settings with the optimal user interface set values of the user interface settings displayed on the user interface setting verification screen 141, thereby changing the user interface settings.

As a result, the user interface settings of the DSC 101 have been changed to the user interface settings desired by the user.

At this point, the MPU 110 generates person-specific user interface setting information on the target user describing the optimal user interface set values of the user interface settings displayed on the user interface setting verification screen 141. The MPU 110 proceeds to store the generated person-specific user interface setting information into the user interface setting information recording block 123 along with the face image of the target user.

In this case, the MPU 110 also writes the file name of the target user's face image to the person-specific user interface setting information in order to associate the target user's face image with the person-specific user interface setting information regarding the target user.

Thereafter, whenever the face image of the target user is selected again, the MPU 110 reads the person-specific user interface setting information associated with the target user's face image instead of the attribute-specific user interface setting information in order to change the user interface settings. The MPU 110 then displays on the user interface setting verification screen 141 the optimal user interface set values of the user interface settings described in the person-specific user interface setting information in question.

As described, the DSC 101 first uses the attribute-specific user interface setting information to change settings to the user interface settings suited for the target user, and stores the changed user interface settings as the person-specific user interface setting information. If it is desired to change the settings again to the user interface settings suited for the target user, the DSC 101 utilizes the person-specific user interface setting information instead of the attribute-specific user interface setting information.

With the DSC 101, the user can change the optimal user interface set values regarding the target user, and the changed optimal user interface set values are retained as the person-specific user interface setting information. Thereafter, whenever the target user is selected, the changed optimal user interface set values are reflected in the user interface settings.

Furthermore, the DSC 101 is arranged to let the user interface settings suited for the target user be replaced simply with the default user interface settings as needed. The default user interface settings constitute the initial user interface settings of which the user interface set values are recorded beforehand in the user interface setting information recording block 123.

More specifically, while a face frame Fr is being superposed on an image, the MPU 110 of the DSC 101 may recognize any portion other than the face frames Fr getting touched. In such a case, the MPU 110 reads the default user interface settings from the user interface setting information recording block 123.

The MPU 110 then causes the display device 117 to display the user interface setting verification screen 141 showing the user interface set values of the default user interface settings. Upon recognizing the OK button 142 getting pressed on the user interface setting verification screen 141, the MPU 110 changes the current user interface settings to the default user interface settings.

The DSC 101 thus changes the user interface settings to the default user interface settings in response to a simple operation of the user touching any portion other than the face frame Fr on the screen.

As described so far, the DSC 101 changes the user interface settings to the settings suited for the target user or changes the settings back to the default user interface settings when the user simply touches the displayed image.

Also, when communication is established with the administrative server 102 through the network interface 122, the MPU 110 downloads the latest attribute-specific user interface setting information from the administrative server 102. The latest information thus downloaded is used to update the attribute-specific user interface setting information recorded in the user interface setting information recording block 123.

At this point, the MPU 110 uploads to the administrative server 102 the person-specific user interface setting information recorded in the user interface setting information recording block 123.

Upon receipt via the network interface 133 of the person-specific user interface setting information from the DSC 101, the CPU 130 of the administrative server 102 records the received information to the hard disk 131.

In that manner, the hard disk 131 of the administrative server 102 accumulates the person-specific user interface setting information uploaded from a number of DSC's 101.

Based on the person-specific user interface setting information stored on the hard disk 131, the CPU 130 of the administrative server 102 updates the attribute-specific user interface setting information to be offered to the DSC's 101.

More specifically, the CPU 130 first categorizes the person-specific user interface setting information stored on the hard disk 131 by age bracket and by gender, such as “boys under 10.” For each of these categories, the CPU 130 takes statistics of the optimal user interface set values of each of the user interface settings described in the person-specific user interface setting information regarding target users. In so doing, the CPU 130 determines the priorities of selection for the user interface set values with regard to each user interface setting.

For example, suppose that statistics are taken of the optimal user interface set values of a user interface setting called “sound volume” described in the person-specific user interface setting information grouped into the category of “boys under 10,” and that the statistical process has yielded 10 “normal” set values, 11 “high” set vales, and 5 “low” set values.

In that case, with regard to the user interface setting “sound volume” for “boys under 10,” the CPU 130 determines the priority of selection to be “2” for “normal,” “1” for “high,” and “3” for “low.”

Based on the priorities of selection thus determined, the CPU 130 updates the attribute-specific user interface setting information on each category stored on the hard disk 131.

As described, the CPU 130 updates the attribute-specific user interface setting information in such a manner that the priority of selection for each user interface set value actually desired by as many target users as possible will be maximized.

This in turn allows the administrative server 102 to provide the DSC 101 with the attribute-specific user interface setting information denoting the user interface settings suitable for the target user in question.

### [1-2-3. User Interface Setting Changing Routine]

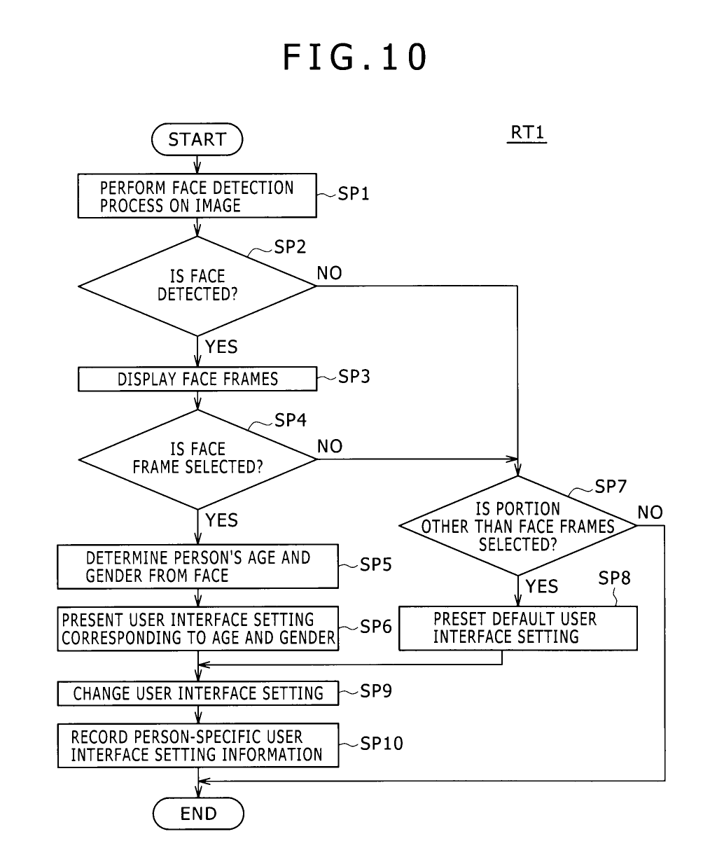

Described below in reference to the flowchart of FIG. 10 is a routine RT1 for changing user interface settings (called the user interface setting changing routine hereunder). Explained hereunder is the user interface setting changing routine RT1 for use where only the attribute-specific user interface setting information is recorded in the user interface setting information recording block 123 to which the person-specific user interface setting information has yet to be written.

Incidentally, the user interface setting changing routine RT1 is carried out by the MPU 110 of the DSC 101 in accordance with programs stored in an internal ROM.

In reproduction mode, the MPU 110 may recognize the target user selection button 140A getting pressed while an image is being displayed on the display device 117. At this point, the MPU 110 starts the user interface setting changing routine RT1 and goes to step SP1.

In step SP1, the MPU 110 controls the camera signal processing block 115 to perform a face detection process on the image being displayed. Step SP1 is followed by step SP2 in which the MPU 110 checks to determine whether any face is detected from the image as a result of the face detection process by the camera signal processing block 115.

If the result of the check in step SP2 is affirmative, with a face detected from the image, then the MPU 110 goes to step SP3. In step SP3, the MPU 110 controls the display processing block 116 to display a face frame Fr on the displayed image in keeping with the position and size of the detected face coming from the camera signal processing block 115. From step SP3, the MPU 110 goes to step SP4.

In step SP4, the MPU 110 checks to determine whether the face frame Fr superposed on the image is touched.

If the result of the check in step SP4 is affirmative, that means somewhere inside the face frame Fr has been touched, i.e., that the person with his or her face enclosed by the face frame Fr is selected as the target user. The MPU 110 then goes to step SP5.

In step SP5, the MPU 110 controls the camera signal processing block 115 to generate a face image of the target user by isolating the portion enclosed by the face frame Fr from the image being displayed. The MPU 110 proceeds to determine the age bracket and gender of the target user by performing image analysis on the face image. The MPU 110 then goes to step SP6.

In step SP6, the MPU 110 displays on the user interface setting verification screen 141 the optimal user interface set values of each of the user interface settings described in the attribute-specific user interface setting information regarding the category corresponding to the age bracket and gender of the target user thus determined. From step SP6, the MPU 110 goes to step SP9.

If the result of the check in step SP4 is negative, with nowhere inside the face frame Fr determined to be touched, the MPU 110 goes to step SP7.

In step SP7, the MPU 110 checks to determine whether any portion other than the face frame Fr displayed on the image is touched.

If the result of the check in step SP7 is affirmative, with somewhere outside the face frame Fr determined to be touched, the MPU 110 goes to step SP8. In step SP8, the MPU 110 displays on the user interface setting verification screen 141 the default optimal user interface set values of each of the user interface settings. From step SP8, the MPU 110 goes to step SP9.

In step SP9, the MPU 110 changes the user interface settings by replacing the current user interface set values of each of the user interface settings with the optimal user interface set values of each user interface setting displayed on the user interface setting verification screen 141. As discussed above, the user interface setting verification screen 141 is arranged to let the user change the optimal user interface set values of each user interface setting as needed. Thus in step SP9, the MPU 110 changes the user interface settings to the optimal user interface set values of each of the user interface settings that are being displayed when the OK button 142 is pressed on the user interface setting verification screen 141.

After changing the user interface setting as described, the MPU 110 goes to step SP10. In step SP10, the MPU 110 generates person-specific user interface setting information on the target user describing the changed optimal user interface set values of the user interface settings, and stores the generated person-specific user interface setting information along with the face image of the target user. After performing step SP10, the MPU 110 terminates the user interface setting changing routine RT1.

If the result of the check in step SP7 is negative, with neither the face frame Fr nor the portion outside the face frame Fr determined to be touched, that means the user is not about to change the user interface settings. In this case, the MPU 110 terminates the user interface setting changing routine RT1.

As described, the MPU 110 changes the user interface settings according to the user interface setting changing routine RT1.

If the person-specific user interface setting information is recorded beforehand in the user interface setting information recording block 123, the MPU 110 in step SP5 searches for the person-specific user interface setting information associated with the face image of the same person as the selected target user.

Suppose that the search above has detected the person-specific user interface setting information on the target user which is found recorded. If that is the case, the MPU 110 immediately goes to step SP6 and displays on the user interface setting verification screen 141 the optimal user interface set values of each of the user interface settings described in the person-specific user interface setting information of interest.

On the other hand, if the search above has not detected the person-specific user interface setting information about the target user, then the MPU 110 determines the age bracket and gender of the target user in step SP5 as discussed above, and goes to step SP6. In step SP6, the MPU 110 displays on the user interface setting verification screen 141 the optimal user interface set values of each of the user interface settings described in the attribute-specific user interface setting information corresponding to the age bracket and gender determined for the target user.

### [1-2-4. Functional Structures of the DSC]

What follows is a simple explanation of the functional structures of the camera signal processing block 115 and MPU 110 incorporated in the DSC 101, with emphasis on the arrangements for changing user interface settings.

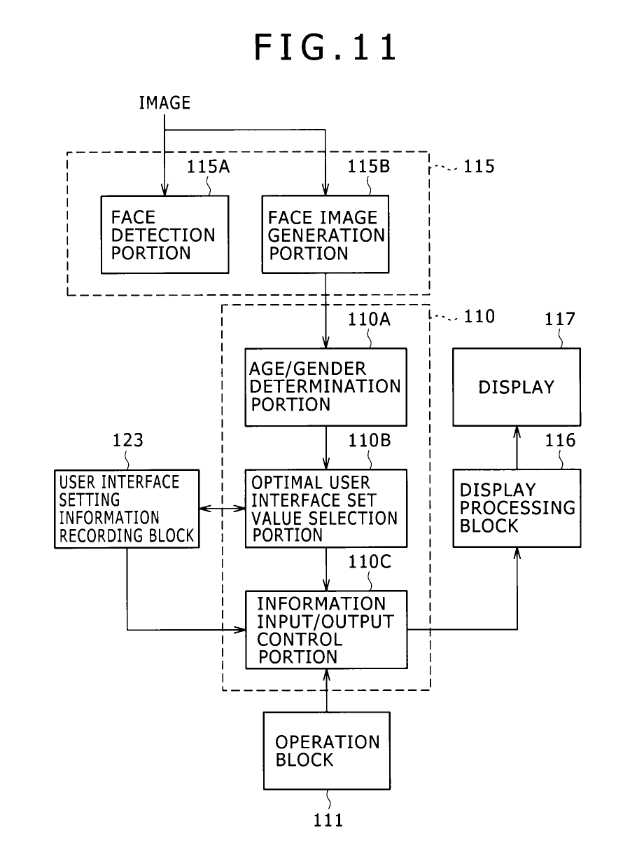

As shown in FIG. 11, the camera signal processing block 115 is functionally constituted by a face detection portion 115A and a face image generation portion 115B; and the MPU 110 is functionally formed by an age/gender determination portion 110A, an optimal user interface set value selection portion 110B, and an information input/output control portion 110C.

The face detection portion 115A in the camera signal processing block 115 is a functional block that detects faces. The face detection portion 115A performs a face detection process on the input image (e.g., currently displayed image) and acquires the position and size of a face detected from the image.

The face image generation portion 115B is a functional block that generates face images. The face image generation portion 115B generates the face image of the target user by isolating from the input image the portion defined by the position and size of the face image acquired by the face detection portion 115A.

The age/gender determination portion 110A is a functional block that determines the age bracket and gender of the target user. The age/gender determination portion 110A determines the age bracket and gender of the target user by carrying out image analysis on the target user's face image generated by the face image generation portion 115B.

The optimal user interface set value selection portion 110B is a functional block that selects the user interface set values best suited for the target user. The optimal user interface set value selection portion 110B selects the optimal (i.e., best-suited) user interface set values for the target user illustratively on the basis of the attribute-specific user interface setting information about the category corresponding to the age bracket and gender of the target user determined by the age/gender determination portion 110A.

The information input/output control portion 110C is a functional block that permits input and output of diverse kinds of information. The information input/output control portion 110C causes the display processing block 116 to display on the display device 117 the optimal user interface set values selected illustratively by the optimal user interface set value selection portion 110B.

Also, the information input/output control portion 110C recognizes the user's operations through the operation block 111. Illustratively, the information input/output control portion 110C may select the target user in response to a touch on the face frame Fr or may change optimal user interface set values in keeping with operations for changing these set values. Furthermore, the information input/output control portion 110C may record the person-specific user interface setting information to the user interface setting information recording block 123 when the OK button 142 is pressed on the user interface setting verification screen 141.

The functional structures described above enable the DSC 101 to change the user interface settings as needed. The hardware structures of the camera signal processing block 115 and MPU 110 in the DSC 101 are not limited to what is shown in FIG. 3; other suitable hardware structures may be adopted as long as they are designed to implement the aforementioned functional structures.

### [1-2-5. Operations and Effects]

The DSC 101 structured as described above retains the attribute-specific user interface setting information denoting the user interface settings suited for the target users corresponding to each of the categories by age bracket and by gender.

When a person's face is selected from a given image, the DSC 101 regards the selected person as the target user and performs image analysis on the target user's face image, thereby determining the age bracket and gender of the target user.

Also, from the attribute-specific user interface setting information of the category corresponding to the age bracket and gender of the target user thus determined, the DSC 101 acquires the optimal user interface set values indicative of the user interface settings suitable for the target user.

With the optimal user interface set values displayed on the display device 117, the DSC 101 replaces the current user interface set values with the displayed optimal user interface set values in response to the user's operations. In this manner, the user interface settings are changed to the settings suited for the target user.

As described, the DSC 101 may change the user interface settings to those user interface settings suited for the target user by simply selecting the target user's face from the displayed image. There is no need for the target user to input such attributes as his or her age and gender; the DSC 101 can thus be operated in easy-to-use fashion from the very beginning.

If a single DSC 101 is shared by a plurality of target users, each user need only select his or her face from the image that includes the users' faces. Simply selecting his or her own face image changes the settings to the user interface settings suited for the target user.

Furthermore, since the person whose face was selected from the displayed image is regarded as the target user as discussed above, another user other than the target user may get the user interface settings changed into those suitable for the target user.

For example, a child's father may select the child's face from the displayed image in order to change the user interface settings of the DSC 101 into the settings suited for the child.

In addition, when communication is established with the administrative server 102 over the network NT, the DSC 101 downloads the latest attribute-specific user interface setting information from the administrative server 102. The latest downloaded information is used to update the old attribute-specific user interface setting information.

In that manner, the DSC 101 may illustratively provide the target user with the user interface of a currently popular screen design. In this case, the administrative server 102 offers the data of the new screen design to the DSC 101 along with the latest attribute-specific user interface setting information.

When structured as described above, the DSC 101 identifies a plurality of attributes of the target user who need only be designated from the displayed image. There is no need for the target user to input his or her attributes such as age bracket and gender. The DSC 101 proceeds to change the user interface settings based on the multiple attributes thus identified.

### <2. Other Embodiments>

### [2-1. First Variation]

In the foregoing description of the preferred embodiment of the present invention, with any image displayed on the display device 117 in reproduction mode, the menu 140 was shown to be displayed in response to the user's operations so that the target user's face may be selected using the menu 140.

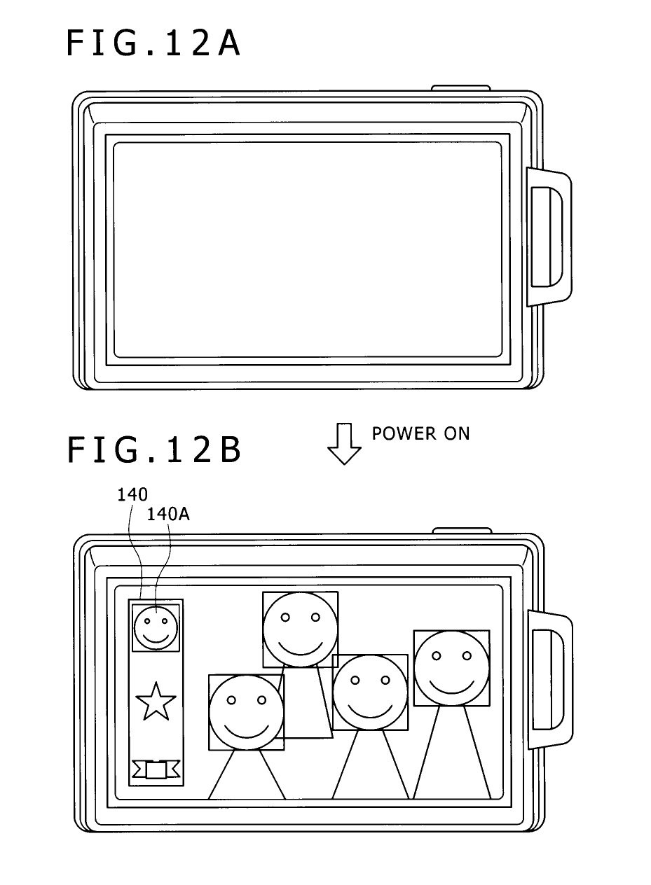

Alternatively, as illustrated in FIGS. 12A and 12B, when the DSC 101 is turned on, the menu 140 may be arranged to appear together with a predetermined image designated for the selection of a target user. This arrangement allows the target user's face to be selected immediately upon power-up.

If a single DSC 101 is shared by a plurality of target users, an image showing the multiple users need only be designated as the image for target user selection.

This makes it possible for any one of the multiple target users to select his or her face upon power-up of the DSC 101 so that the user in question can immediately start using the DSC 101 in a state ensuring the ease of use for the target user.

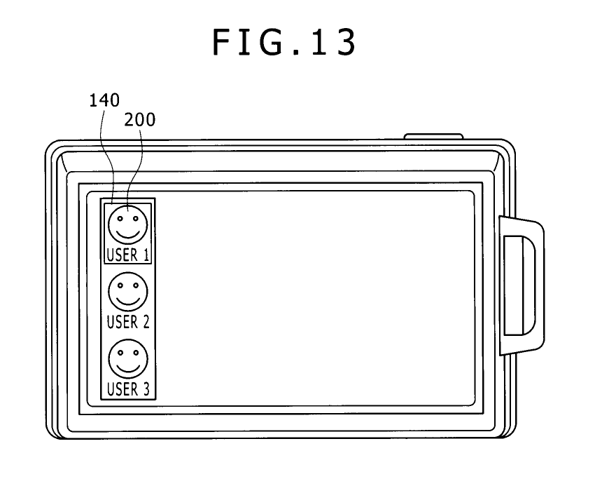

With regard to the target users whose person-specific user interface setting information has been recorded together with their face images, face image icons 200 of these target users may be arranged to appear in the menu 140 as shown in FIG. 13. In this case, when any one of the face image icons 200 is pressed, the MPU 110 of the DSC 101 immediately retrieves the person-specific user interface setting information represented by the face image icon 200 in question and changes the user interface settings accordingly.

With the above arrangement in place, the face of a given target user may be selected from a given image only once. Thereafter, the face image icon 200 corresponding to this target user need only be pressed when needed; the user interface settings suited for the target user will then be brought into effect.

Alternatively, the face image icons 200 may be displayed on a login screen of the DSC 101. The user interface settings may then be changed at login.

### [2-2. Second Variation]

In the foregoing description of the preferred embodiment, the person-specific user interface setting information was shown to be uploaded to the administrative server 102. Alternatively, the attribute-specific user interface setting information may be uploaded to the administrative server 102.

In this case, it makes no sense if the attribute-specific user interface setting information downloaded from the administrative server 102 is uploaded unchanged to that server 102. If the optimal user interface set values are changed on the user interface setting verification screen 141, the attribute-specific user interface setting information is changed correspondingly.

More specifically, the user might change an optimal user interface set value on the user interface setting verification screen 141. In that case, the MPU 110 changes the attribute-specific user interface setting information in a manner bringing to “1” the priority of selection for the changed optimal user interface set value.

Illustratively, suppose that the attribute-specific user interface setting information describes selectable user interface set values “normal,” “high,” and “low” for the user interface setting “sound volume” and that these set values are assigned “1,” “2,” and “3,” respectively, as their priorities of selection.

In that case, the user interface setting verification screen 141 displays “normal” as the optimal user interface set value for “sound volume.” Suppose now that the user changes the optimal user interface set value of “sound volume” from “normal” to “low,” before pressing the OK button 142.

In response, the MPU 110 updates the attribute-specific user interface setting information by setting “1,” “2” and “3” as the priorities of selection for the user interface set values “low,” “normal” and “high” respectively, with regard to the user interface setting “sound volume.”

When the attribute-specific user interface setting information is updated in the manner described above, the attribute-specific user interface setting information recorded in the user interface setting information recording block 123 of the DSC 101 is made more relevant and personalized for the target user of the DSC 101 than ever before.

Then the MPU 110 uploads the attribute-specific user interface setting information thus updated to the administrative server 102.

When the uploading steps above are taken, the administrative server 102 can get hold of the user interface set values desired by as many target users as possible, as in the case of the person-specific user interface setting information getting uploaded to the administrative server 102. The attribute-specific user interface setting information can then be updated to give higher priorities of selection to the user interface set values desired by the many users.

### [2-3. Third Variation]

In the foregoing description of the preferred embodiment, the user interface settings were shown to be changed based on the attribute-specific user interface setting information of the category corresponding to the target user's age bracket and gender determined from the face image of the target user in question.

Alternatively, various other attributes may be utilized as long as these attributes can be determined from the target user's face image. In such a case, the attribute-specific user interface setting information should obviously be made to correspond with the attributes to be utilized.

For example, in addition to the age bracket and gender, the race of the target user may be used as an attribute. In this case, there should be provided attribute-specific user interface setting information of the categories by age bracket, by gender, and by race. From the face image of a given target user, the DSC 101 determines the age bracket, gender, and race of that user. The DSC 101 then changes the user interface settings based on the attribute-specific user interface setting information of the category corresponding to the age bracket, gender, and race thus determined with regard to the target user.

That is, the larger the number of the attributes to be determined from the face image of the target user, the more suited the user interface settings are for the target user when they are changed.

In addition to the attributes of the target user, current position information obtained from the GPS module 121 may be used. In this case, there should be provided attribute-specific user interface setting information of the categories by age bracket, by gender, and by current position. The DSC 101 then changes the user interface settings based on the age bracket and gender determined from the face image of the target user as well as in keeping with the attribute-specific user interface setting information of the category corresponding to the current position information acquired from the GPS module 121.

Where the arrangement above is in place, the user interface settings may be changed in such a manner that a character unique to a given geographical area may be displayed as the assistant offering operation guidance.

In this case, the administrative server 102 provides the DSC 101 with data of the area-specific characters together with the attribute-specific user interface setting information.

### [2-4. Fourth Variation]

As explained above in connection with the preferred embodiment, once the face of the target user is selected, the user is prompted to verify the optimal user interface set values of each of the user interface settings through the user interface setting verification screen 141. After the OK button 142 is pressed, the user interface settings are changed.

Alternatively, once the target user's face is selected, the user interface settings may be changed without displaying the user interface setting verification screen 141. In this case, the user interface setting verification screen 141 may be arranged to be displayed only if such a display is requested by the user's operation.

### [2-5. Fifth Variation]

Also in the foregoing description of the preferred embodiment, the default user interface settings were shown to be recorded in the user interface setting information recording block 123 of the DSC 101. Alternatively, the DSC 101 may download from the administrative server 102 the user interface setting information denoting the default user interface settings together with the attribute-specific user interface setting information.

Also in the foregoing description of the preferred embodiment, the DSC 101 was shown to communicate directly with the administrative server 102 in order to download the attribute-specific user interface setting information therefrom. Alternatively, a personal computer having a network connection capability may download the attribute-specific user interface setting information from the administrative server 102, before transferring the downloaded information to the DSC 101.

In this case, the DSC 101 can dispense with its network connection capability. That means the DSC 101 can be structured more simply than before.

### [2-6. Sixth Variation]

The foregoing description of the preferred embodiment further showed that it is possible to change the user interface settings of “type of text (for display on the screen),” “font size,” “sound volume,” “screen design,” “type of assistant (offering operation guidance),” and “text-to-speech reading function (being on/off).”

Alternatively, other diverse user interface settings may be arranged to be changed as long as the changes can be accomplished on the DSC 101. For example, camera settings may be arranged to be changed as part of the user interface settings. In this case, the set values of the camera settings need only be described in the attribute-specific user interface setting information.

### [2-7. Seventh Variation]

Also in the foregoing description of the preferred embodiment, the DSC 101 as an information processing apparatus was shown to have the camera signal processing block 115 as the detection block. It was further shown that the DSC 101 is provided with the MPU 110 as the setting changing block and display control block, with the user interface setting information recording block 123 as the recording block, with the network interface 122 as the communication block, and with the GPS module 121 as the positioning block.

Alternatively, the function blocks enumerated above may be implemented otherwise by diverse kinds of hardware or software as long as the implementation provides the same or equivalent functions.

Whereas the foregoing description of the preferred embodiment showed the present invention to be applied to the DSC 101, this is not limitative of the invention. Alternatively, the invention may be applied to and implemented as digital video cameras, mobile phones, game consoles, personal computers and other kinds of apparatuses as long as they have a changeable user interface.

### [2-8. Eighth Variation]

Also in the foregoing description of the preferred embodiment, the program for executing the aforementioned diverse processes was shown to be written in the ROM of the MPU 110.

Alternatively, the program may be recorded in a recording medium such as a memory card. In operation, the MPU 110 of the DSC 101 may then read the program from the recording medium for program execution. As another alternative, the MPU 110 may be furnished with a recording block such as a flash memory into which the program retrieved from the recording medium may be installed.

### [2-9. Ninth Variation]

The present invention is not limited to the above-described preferred embodiment or to its variations outlined above. It is thus intended that the present invention embrace any combination of the preferred embodiment with part or all of its variations; an extracted part or parts of the embodiment and its variations; and other alternatives, modifications, and examples of the invention as fall within the spirit and scope of the appended claims. Overall, the present invention can be applied extensively to varieties of apparatuses whose user interface is designed to be changeable.

The present application contains subject matter related to that disclosed in Japanese Priority Patent Application JP 2009-261093 filed in the Japan Patent Office on Nov. 16, 2009, the entire content of which is hereby incorporated by reference.

What is claimed is:

1. An information processing apparatus comprising:
a detection block configured to detect persons from an image; and
a setting changing block configured such that if one of the persons detected by said detection block from said image is designated, then said setting changing block identifies a plurality of attributes of the designated person based on the image of said person, before changing user interface settings using attribute-specific setting information associated with a combination of the identified multiple attributes.

2. The information processing apparatus according to claim 1, wherein, if any portion other than the persons detected by said detection block from said image is designated, then said setting changing block changes the user interface settings to initial settings.

3. The information processing apparatus according to claim 1, wherein said attribute-specific setting information describes set values for changing the user interface settings; and
said setting changing block changes the user interface settings using the set values described in said attribute-specific setting information.

4. The information processing apparatus according to claim 3, wherein said setting changing block causes a display block to display the set values indicated in the attribute-specific setting information associated with the combination of said identified multiple attributes and, in response to operations by a user to change the displayed set values, changes the displayed set values while changing the user interface settings using the changed set values.

5. The information processing apparatus according to claim 1, wherein said setting changing block causes a recording block to record person-specific setting information indicative of the changed user interface settings in association with the image of said person.

6. The information processing apparatus according to claim 5, further comprising
a communication block configured to communicate with an external apparatus;
wherein said communication block receives said attribute-specific setting information from said external apparatus while transmitting said person-specific setting information to said external apparatus.

7. The information processing apparatus according to claim 1, further comprising
a positioning block configured to determine a current position; wherein
said attribute-specific setting information is recorded in a recording block in conjunction with combinations of said plurality of attributes with the current position, and
said setting changing block changes the user interface settings using said attribute-specific setting information associated with combinations of said identified multiple attributes with the current position determined by said positioning block.

8. The information processing apparatus according to claim 1, further comprising
a display control block configured to display a predetermined image on a display block when turned on;
wherein
said detection block detects persons from the image displayed on said display block, and
if one of the persons detected by said detection block from the image displayed on said display block is designated, then said setting changing block identifies a plurality of attributes of the designated person based on the image of said person, before changing user interface settings using attribute-specific setting information associated with a combination of the identified multiple attributes.

9. A setting changing method comprising the steps of:
detecting persons from an image; and
if one of the persons detected in said detecting step from said image is designated, then determining a plurality of attributes of the designated person based on the image of said person, before changing user interface settings using attribute-specific setting information associated with a combination of the identified multiple attributes.

10. A setting changing program for use with an information processing apparatus including a detection block and a setting changing block, said setting changing program comprising the steps of:
causing said detection block to detect persons from an image; and
if one of the persons detected by said detection block from said image is designated, then causing said setting changing block to identify a plurality of attributes of the designated person based on the image of said person, before changing user interface settings using attribute-specific setting information associated with a combination of the identified multiple attributes.

11. An information processing apparatus comprising:
detection means for detecting persons from an image; and
setting changing means for, if one of the persons detected by said detection means from said image is designated, identifying a plurality of attributes of the designated person based on the image of said person, before changing user interface settings using attribute-specific setting information associated with a combination of the identified multiple attributes.
